(19) United States
(12) Patent Application Publication
(10) Pub. No.: US 2006/0078651 A1
(43) Pub. Date: Apr. 13, 2006

(54) Supplemented sesame ice cream

(76) Inventor: Mehrdad Esghipour, Germantown, MD (US)

Correspondence Address: LAW OFFICES OF KHALILIAN SIRA, LLC, 9100 PERSIMMON TREE ROAD, POTOMAC, MD, 20854, US

(21) Appl. No.: 10/962,652

(22) Filed: Oct. 13, 2004

(51) Int. Cl. A23G 9/00

(52) U.S. Cl. 426/101

(57) ABSTRACT

The invention provides a supplemented desert comprising a sweetened dairy composition containing sesame seed paste, roasted sesame seed, and an effective amount of at least one nutraceutical. Specifically, the invention provides a supplemented vanilla ice cream containing from about 850 to about 946 ml of a vanilla ice cream, from about 1 to about 3 ounces of black sesame seed paste, from about 1 to about 3 ounces of roasted sesame seed, from about 1 to about ¼ teaspoon of vanilla extract; and an effective amount of a nutraceutical.

### I. FIELD OF THE INVENTION

This invention relates to supplemented food products. In particular, the invention relates to supplemented sesame food products.

### II. BACKGROUND OF THE INVENTION

The general population is more knowledgeable today about their nutritional requirements and the importance of consumption of healthy food products in achieving a superior quality of life than ever before, and the trend is growing. The growing interest in the field of nutrition has led to consumers scrambling for new food products that were not previously considered to be of critical importance, nor did many suppliers of food products have the incentives to explore healthier food products. The knowledge of how to produce food products that not only meet the nutritional and health requirements of today while still being delicious and enjoyable has become instrumental in wellness and longevity of the general public. As a result, thousands of health conscious consumers are now desperately seeking alternative foods that are not only delectable but boost their energy and stimulate their immune systems.

Nutritional supplements are a topic of great public interest. Some uses of nutritional supplements have become a part of the conventional diet. The consumer's interest in nutritional supplements is growing and classical suppliers of food today need to bridge the gap and implement nutritional supplements into classical food products.

U.S. Pat. No. 6,030,650 discloses nutritional dairy-products having a composition containing a variety of vitamins and supplements.

U.S. Pat. No. 6,174,542 discloses chocolate containing dietary deserts containing a variety of vitamins, mineral and herbal supplements for treating, preventing, alleviating or managing symptoms associated with premenstrual syndrome (PMS) in women. U.S. Pat. No 5,869,125 discloses whipped dairy products having low fat compositions wherein at least a portion of the fat is a vegetable oil.

The advent of producing low carbohydrate or low fat diets has allowed many classical suppliers of food to produce food products that appeal to weight-conscious consumers. Unfortunately, the majority of these foods have lost their flavor and zest and their nutritional values are under scrutiny by food scientists. The desire to produce high flavor food with increased nutritional value has led food scientists to investigate traditional culinary substances such as sesame seed.

The seeds of the sesame plant Sesamum indicum are one of the oldest seeds known to man. It is thought to have originated in India or Africa, the first written record of sesame dates back to 3,000 B.C. References can be found to Babylonians using sesame oil and to Egyptians growing their own sesame to make flour.

Persia has long been savvy to sesame's benefits. Ancient Persians relied on it both as a food and for its medicinal qualities. Farther east, it's unclear when sesame first found its way to China. Some sources claim the Chinese were using sesame oil in their lamps as far back as 5,000 years ago, while others state sesame seeds were introduced into China about 2,000 years ago. While the exact circumstances surrounding sesame's arrival in China may be lost to history, there is no doubt that today it is a mainstay of Chinese cuisine. Toasted sesame seeds are sprinkled on salads, sesame paste is added to sauces, and delightfully aromatic sesame oil is used to flavor everything from dips to marinades.

Sesame seeds are featured in many Asian cuisines. Spice paste concoctions made with sesame seeds enhance Indian dishes, and sesame seeds play a role in Japanese vegetarian cooking. In China, sesame seeds are used to flavor savory dishes. Both black and white sesame seeds are used in Chinese cooking. A third variety of beige colored sesame seeds is not as popular. Like sesame oil, white sesame seeds have a nutty flavor, while black sesame seeds taste slightly bitter. However, whether a recipe calls for white or black seeds often has to do with both the appearance and flavor. While white sesame seeds are nearly always toasted before using, there are differing opinions over the value of toasting black sesame seeds, as it can accentuate the bitter flavor.

Another way to use sesame in food is the use of sesame paste. Sesame paste has a rich aroma, in color and texture it resembles peanut butter, which is often recommended as a substitute. Toasting sesame seeds to make sesame paste is a time honored culinary technique, giving the paste a different flavor than Mediterranean tahini, which is made from untoasted seeds.

Although sesame seeds or sesame pastes have been used in variety of savory dishes, marinades and dips, their use has not been popular with deserts and sweet dishes. This is partly because of the specific flavor of sesame seeds that makes it difficult to incorporate them into desert products.

What is desirable then are desert products containing sesame seeds and/or sesame pastes that not only appeal to the public because of their superior flavor and texture, but also because of their excellent nutritional index. The improvement in the nutritional values of desert products is specifically desirable because, historically, many types of deserts, such as ice cream, have been categorized as high risk food. This invention solves these and other long felt needs by providing delicious desert products containing a novel combination of ingredients that have high nutritional values and superior taste.

### III. SUMMARY OF THE INVENTION

The invention, as disclosed and described herein, provides desert compositions containing sweetened dairy or non-dairy products, sesame seed paste, and roasted sesame seed. Sesame seed and sesame paste are from black sesame seeds, white sesame seeds, beige sesame seeds, or a combination thereof. In particular, the invention provides supplemented desert compositions containing black sesame seed paste, roasted sesame seed, and an effective amount of at least one nutraceutical.

The nutraceuticals within the scope of the invention includes, by way of example and not limitation, vitamins, such as for example, vitamin C, vitamin E, vitamin D, beta-carotene, vitamin K, thiamine, riboflavin, niacin, vitamin B6, folate, vitamin B12, biotin, pantothenic acid, or a combination thereof; minerals such as for example, phosphorus, iodine, magnesium, zinc, selenium, copper, manganese, iron, or a combination thereof; vegetables such as, for example, St. John's wort, cayenne, ginger, ginseng; herbal extracts, or a combination thereof.

In one embodiment, the supplemented desert of the invention is a whipped desert, a frozen desert, or both. The whipped desert or frozen desert includes, for example, ice cream, frozen yogurt, whipped topping, bakery glaze, frozen-fruit puree, sorbet, sherbet, mousse, custard, chiffon, meringue, gelato, shake, juice, cappuccino, hard candies, soft candies, granola bars, chocolate bars, cookies, chocolate brownies, and cakes, among others.

In a preferred embodiment, the supplemented desert of the invention is ice cream. Ice creams are, for example, low fat ice creams, low carbohydrate ice creams, standard ice creams, premium ice creams, super premium ice creams, or a combination thereof.

In one embodiment, the ice cream is a supplemented flavored ice cream selected from the group consisting of chocolate, strawberry, vanilla, banana, raspberry, coffee, mocha, pistachio, peach, or a combination thereof.

In another embodiment, the flavored ice cream additionally contains a flavor extract which is the same or different from the ice cream flavor.

In another embodiment, the supplemented flavored ice cream is a vanilla ice cream that additionally contains vanilla extract.

In yet another embodiment, the supplemented flavored vanilla ice cream contains per quart (1 US quart=946.35295 milliliters) from about 850 to about 946 ml of the vanilla ice cream, from about 1 to about 3 ounces of black sesame seed paste, from about 1 to about 3 ounces of roasted sesame seed, about ¼ teaspoon of vanilla extract; and an effective amount of a nutraceutical.

In another embodiment, the supplemented flavored vanilla ice cream contains about 946 ml of vanilla ice cream, 2 ounces of black sesame seed paste, 2 ounces of roasted sesame seed, about ¼ teaspoon of vanilla extract; and an effective amount of vitamin E.

In one embodiment, the sweetened dairy composition contains milk selected from the group consisting of fat-free milk, low-fat milk, full-fat milk, lactose-free milk, concentrated milk, soy bean milk, dry milk, organic milk, or a combination thereof. The sweetened dairy composition contains natural sweeteners, artificial sweeteners, or both.

### IV. DETAILED DESCRIPTION OF THE INVENTION

Novel desert compositions are disclosed herein. In particular, the present invention discloses supplemented deserts containing a sweetened dairy composition containing sesame seed paste, roasted sesame seed, and an effective amount of at least one nutraceutical.

The desert compositions of the present invention can be formulated into different types of dairy or non-dairy products. Designing new products that require dairy ingredients presents challenges not only when formulating but also when processing and evaluating the finished product performance. It is a particular challenge to use liquid dairy ingredients such as regular milk, cream, sour cream, yogurt and buttermilk safely and effectively in a finished product.

The products can be unflavored or flavored. Preferably the desert composition of the invention is a supplemented flavored desert including dairy or non-dairy compositions. The supplemented deserts within the scope of the invention include, by the way of example and not limitation, ice cream, frozen yogurt, whipped topping, bakery glaze, frozen-fruit puree, sorbet, sherbet, mousse, custard, chiffon, meringue, gelato, shake, juice, cappuccino, hard candies, soft candies, gum, granola bars, chocolate bars, cookies, chocolate brownies, or a combination thereof, among others.

According to a preferred embodiment of the invention, the supplemented desert of the invention comprises a frozen product, a whipped product or both. The frozen and/or whipped products include ice cream, frozen yogurt, or other frozen desserts, such as for example, sherbets, sundaes, or partially frozen desserts, such as milk shakes that can suitably be made from the inventive compositions. The ice creams can be formulated into a standard ice cream containing about 10% milk fat, a premium ice cream containing about 15% milk fat and a super premium ice cream containing about 17% milk fat.

Whipped products contain a certain amount of added air. Without the air, the frozen desserts would be icy and impossible to scoop by hand. A whipped product delivers flavor in a different way than a heavy, dense one. By incorporating air into a liquid or semisolid, the surface volume of the product increases, and therefore, the aromatic quality of the finished dessert intensifies. The term “overrun” refers to how much air a manufacturer whips into ice cream during its creation, which is determined by the percent increase in volume of ice cream greater than the amount of mix used. Super premium and premium ice creams tend to have low overrun (and higher fat content) than regular ice creams. Along with ice cream, frozen-fruit purees, or sorbets, and sherbets (fruit and dairy products) are frozen as air is incorporated into them, which gives them their light texture. Sugar, added as a sweetener, also acts as a functional ingredient by creating a product that is still soft while frozen. For example, semifreddo is a mousse or custard that is prepared and then frozen without being churned. Its light texture is due to its preparation method, not the freezing portion of the process.

The frozen-dessert category offers one unique eating characteristics, it is consumed when frozen, whereas most whipped desserts are eaten chilled. The term “mousse” applies to a variety of light dessert creams not easily classified elsewhere. Mousses can be made either sweet or savory, depending on the ingredients. Usually, dessert mousses are of the sweet variety. A mousse is similar to a Bavarian cream, which is custard, or chiffon, in that it is light and airy due to the addition of whipped egg whites, whipped cream or both, in some cases. It is generally softer than the Bavarian or chiffon and can contain some form of gelatin or gum.

Meringues are made by whisking egg whites into soft peak foams and then gradually adding granulated sugar. Whisking causes the protein in the egg whites to unfold, forming films that trap the air bubbles, and the sugar stiffens the foam. By varying the amount of sugar in the final mix, the hardness or softness of the final product can be controlled. As the mixing time increases, the bubbles become smaller and more numerous; this increases the volume and makes a more-stable structure. However, over beating will cause the proteins to lose their ability to hold the small air bubbles causing it to lose volume or collapse. Finally, cooking (baking) a meringue will set the structure. During heating, the air bubbles expand, causing the volume to expand until the white's protein network surrounding the bubbles solidifies.

In another embodiment, the inventive compositions can be formulated into a yogurt. Yogurt is produced by culturing the compositions of the present invention with a bacterial culture such as, for example, lactic acid-producing bacteria, Lactobacillus bulgaricus and Streptococcus thermophilus. Yogurts using the inventive compositions can be set yogurts where the fermentation occurs in the final retail container or stirred yogurts where the fermentation occurs in bulk prior to packaging. Furthermore, these yogurts can contain flavors or fruits, can be frozen to provide a frozen yogurt or can be in the form of a drinkable fluid to provide a drinkable yogurt.

The desert compositions of the invention can be flavored with natural or artificial ingredients. Such ingredients may be combined with the inventive compositions to form a substantially uniform flavored product or may be present in a non-uniform manner, such as fruit on the top or the bottom of the inventive yogurt or ice cream composition. Non limiting examples of flavored compositions include chocolate, strawberry, peach, raspberry, vanilla, banana, coffee, mocha, pistachio, peach, or combinations thereof.

The desert composition of the invention may also contain low fat compositions and products. Such low fat compositions include for example one or more animal fats or vegetable fats or oils. Animal fats used within the scope of the inventive desert includes, by the way of example and not imitation, butter, butter oil, cream, concentrated cream, anhydrous milk fat, fractionated milk fat, or mixtures thereof. The vegetable fats or oils used within the scope of the invention include, by way of example and not limitation, any of the vegetable oils normally used in the manufacture of margarine and low fat margarine-like spreads. Typical vegetable oils include coconut oils, palm kernel oil, rapeseed oil, soya oil, sunflower oil, corn oil and the like, including the hydrogenated forms thereof.

In one embodiment, the low fat deserts of the invention contain at least one type of vegetable oil, for example two or more different vegetable oils that provide different effects on the texture of the resulting desert. The ratio of the oils to one another is adjusted to provide the desired firmness of the desert. For example, the higher amount of the coconut oil in the product, the softer the product. The higher the amount of palm kernel oil, the firmer the product.

The desert composition of the invention suitably includes milk from a variety of sources and of different types. For example, the milk in the inventive deserts include fat-free milk, low fat-milk, full-fat milk, lactose-free milk, soy bean milk, concentrated milk, dry milk or organic milk. Fat-free milk is, for example, non-fat or skim milk product. Low-fat milk is typically defined as milk that contains from about 1% to about 2% fat. Full-fat milk often contains about 3.5% fat. Additional milk compositions include high protein and fiber-containing milk, and skim plus non-fat milk solids. Furthermore, where fat-free (non-fat or skim) milk is used the milk may be partially evaporated or has added non-fat milk solids to yield a product with a rich creamy taste. The animal source of the milk is typically a cow, but the inventive compositions are not limited just to cow's milk. For example, milk from sheep, goat, buffalo, camel, llama, mare, or deer may suitably be used.

Various fiber sources may be included in the desert compositions of the present invention. These sources may be selected from such materials as oat fiber, soy fiber, guar gum, pectin, soy polysaccharides, hydrolyzed fibers and the like. The use of cellulose, hemicellulose, hydrocollides, methylcellulose, carboxymethyl cellulose and the like are also contemplated within the scope of the invention.

The desert composition of the invention contains artificial sweeteners, natural sweeteners or both. Sweeteners are derived from a variety sources, including sucrose, corn syrup solids, glucose, fructose, maltodextrin or combinations thereof, among others. Artificial sweeteners used within the scope of the invention include, by way of example and not limitation, saccharine, aspartame, asulfame K, sucrolose, fructo-oligosaccharides, or a combination thereof among others.

In one embodiment, the desert composition of the invention additionally contains an effective amount of at least one nutraceutical. An effective amount of a nutraceutical is an amount that has been recommended as the daily dosage required for a healthy diet as indicated by RDA (Recommended Dietary Allowance). Nutraceuticals are defined as any health-enhancing product derived from nature, including vegetables, vitamins such as pyridoxine (vitamin B6), vitamin E, vitamin C, vitamin D, beta-carotene, vitamin K, thiamine, riboflavin, niacin, vitamin B6, folate, vitamin B12, biotin, pantothenic acid; vegetables such as, for example, kava kava, St. John's wort, cayenne, ginger and ginseng, chickweed, buchu, wild yam; herbal extracts, and minerals such as, for example, phosphorus, iodine, magnesium, zinc, selenium, copper, manganese, iron, or a combination thereof.

All references discussed herein are incorporated by reference. One skilled in the art will readily appreciate that the present invention is well adapted to carry out the objects and obtain the ends and advantages mentioned, as well as those inherent therein. The present invention may be embodied in other specific forms without departing from the spirit or essential attributes thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

What is claimed is:

1. A supplemented desert comprising a sweetened dairy composition containing sesame seed paste, roasted sesame seed, and an effective amount of at least one nutraceutical.

2. The supplemented desert of claim 1, wherein the desert is a whipped desert, a frozen desert, or both.

3. The supplemented desert of claim 1, wherein said desert comprises ice cream, frozen yogurt, whipped topping, bakery glaze, frozen-fruit purée, sorbet, sherbet, mousse, custard, chiffon, meringue, gelato, shake, juice, cappuccino, hard candies, soft candies, gum, granola bars, chocolate bars, cookies, chocolate brownies, or a combination thereof.

4. The supplemented desert of claim 3, wherein said ice cream is selected from the group consisting of a standard ice cream, a premium ice cream, a super premium ice cream or a combination thereof.

5. The supplemented desert of claim 4, wherein said ice cream is a flavored ice cream.

6. The supplemented desert of claim 5, wherein said flavor is selected from the group consisting of chocolate, strawberry, vanilla, banana, raspberry, coffee, mocha, pistachio, peach, or a combination thereof.

7. The supplemented desert of claim 6, wherein said ice cream is a vanilla ice cream and additionally contains vanilla extract.

8. The supplemented desert of claim 1, wherein said sweetened dairy composition contains milk selected from the group consisting of fat-free milk, low-fat milk, full-fat milk, lactose-free milk, concentrated milk, soy bean milk, dry milk, organic milk, or a combination thereof.

9. The supplemented desert of claim 1, wherein said sweetened dairy composition contains artificial sweetener, natural sweetener, or both.

10. The supplemented desert of claim 1, wherein said at least one nutraceutical comprises vitamins, minerals, St. John's wort, cayenne, ginger, ginseng, herbal extract, or a combination thereof.

11. The supplemented desert of claim 10, wherein said vitamins comprise vitamin C, vitamin E, vitamin D, beta-carotene, vitamin K, thiamine, riboflavin, niacin, vitamin B6, folate, vitamin B12, biotin, pantothenic acid, or a combination thereof.

12. The supplemented desert of claim 10, wherein said minerals comprise phosphorus, iodine, magnesium, zinc, selenium, copper, manganese, iron, or a combination thereof.

13. A supplemented vanilla ice cream comprising, per quart:
a) from about 850 to about 946 ml of a vanilla ice cream;
b) from about 1 to about 3 ounces of black sesame seed paste;
c) from about 1 to about 3 ounces of roasted sesame seed;
d) from about 1 to about ¼ teaspoon of vanilla extract; and
e) an effective amount of vitamin E.

14. The supplemented vanilla ice cream of claim 13, wherein said vanilla ice cream is selected from the group consisting of a standard ice cream, a premium ice cream, and a super premium ice cream.

15. The supplemented vanilla ice cream of claim 13, wherein said vanilla ice cream contains milk selected from the group consisting of fat-free milk, low-fat milk, full-fat milk, lactose-free milk, concentrated milk, soy bean milk, dry milk, organic milk, or a combination thereof.

16. The supplemented vanilla ice cream of claim 13, comprising about 946 ml of vanilla ice cream, 2 ounces of roasted sesame seed, 2 ounces of 2 black roasted sesame seed; and ¼teaspoon of vanilla extract.

17. A supplemented flavored ice cream comprising, per quart:
a) from about 850 to about 946 ml of said flavored ice cream;
b) from about 1 to about 3 ounces of black sesame seed paste;
c) from about 1 to about 3 ounces of roasted sesame seed;
d) from about 1 to about ¼ teaspoon of a flavor extract; and
e) an effective amount of at least one nutraceutical.

18. The supplemented flavored ice cream of claim 17, wherein said flavor and said flavor extract are from the same or different sources.

19. The supplemented flavored ice cream of claim 17, wherein said flavor and said flavor extract are selected from the group consisting of chocolate, strawberry, vanilla, banana, raspberry, coffee, mocha, pistachio, peach, or a combination thereof.

20. The supplemented flavored ice cream of claim 16, wherein said at least one nutraceutical comprises vitamins, minerals, vegetables, herbal extracts, or a combination thereof.
